(19) United States
(12) Patent Application Publication
(10) Pub. No.: US 2021/0023916 A1
(43) Pub. Date: Jan. 28, 2021

(54) METHODS AND SYSTEMS FOR OPERATING AN AUTOMATED SUN BLOCKING STRUCTURE

(71) Applicant: GREGORY INNOVATIONS, LLC, Carlsbad, NM (US)

(72) Inventor: Norman Scott GREGORY, Carlsbad, NM (US)

(73) Assignee: GREGORY INNOVATIONS, LLC, Carlsbad, NM (US)

(21) Appl. No.: 16/521,924

(22) Filed: Jul. 25, 2019

(51) Int. Cl. B60J 3/02; F16H 19/04; F16H 19/06; G01S 19/13

(52) U.S. Cl. CPC B60J 3/026; F16H 19/04; F16H 2019/0686; G01S 19/13; F16H 19/06

(57) ABSTRACT

A system for controlling a sun blocking structure in a vehicle is disclosed. The system can automatically move/position the sun blocking structure between ambient light from the sun and a person located in the vehicle. Also, the sun blocking structure can be located in the vehicle such that the system automatically drives the sun blocking structure in a manner that avoids contact between the person and the sun blocking structure. The system includes a GPS unit that provides location information of the vehicle as well as current time and date information to a controller. The controller uses this information to determine a location of the ambient light incident on the vehicle, and provides instructions that cause a motor to move the sun blocking structure to a location between the ambient light and the person's eyes, thereby blocking the person's eyes from direct ambient light.

### BACKGROUND

Sun visors are found in vehicles and are used to block sunlight. A traditional sun visor is commonly found in a corner region of the vehicle, and is designed to rotate about an axis that is approximately aligned with an edge of the sun visor. Based on these design features, the sun visor can rotate to cover a front windshield or a side window.

In order to provide adequate sun blockage, traditional sun visors are relatively long. As a result, the when rotating the sun visor from the front windshield to the side window (or vice versa), the driver manually operates the sun visor and moves his/her head to accommodate the sun visor. Unfortunately, any head movement by the driver in this manner reduces the driver's focus on the road. Such head movement can increase the driver's risk of causing an accident.

### SUMMARY

In one aspect, a system for controlling a sun blocking structure in an automobile is described. The system may include an input mechanism configured to receive an input. The system may further include a controller configured to receive the input from the input mechanism and configured to generate instructions based on the one or more inputs. The system may further include a motor configured to drive the sun blocking structure around a person in the automobile and locate the sun blocking structure between the person and ambient light based on the instructions from the controller.

In another aspect, a motorized vehicle is described. The motorized vehicle may include a vehicle body that includes a ceiling. The motorized vehicle may further include a seat located in the vehicle body and covered by the ceiling. The motorized vehicle may further include a Global Positioning System (GPS) unit carried by the vehicle body. The GPS unit can be configured to receive location coordinates. The motorized vehicle may further include a controller carried by the vehicle body. The controller can be configured to i) receive the location coordinates, ii) determine a direction of travel of the vehicle body, and iii) generate instructions based on the direction of travel. The motorized vehicle may further include a motor coupled with the ceiling and a sun blocking structure. The motor can be configured to translate, based on the instructions, the sun blocking structure around the seat.

In another aspect, a method for controlling a sun blocking structure for a motorized vehicle is described. The method may include determining, by a Global Positioning System (GPS) unit, location coordinates indicative of a location of the motorized vehicle. The method may further include determining, by the GPS unit, a direction of travel of the motorized vehicle based on the location coordinates. The method may further include providing, by the GPS unit, a direction of travel of the motorized vehicle to a system controller. The direction of travel can be based on the location coordinates. The method may further include providing, by the system controller, instructions to a motor controller based on the direction of travel. The motor controller can be configured to generate a control signal based on the instructions. The method may further include positioning, by a motor, the sun blocking structure between a person and ambient light based on the control signal being provided to the motor.

### BRIEF DESCRIPTION OF THE DRAWINGS

For a detailed description of example embodiments, reference will now be made to the accompanying drawings in which:

FIG. 1 shows an isometric view of an embodiment of a vehicle with a sun blocking structure;

FIG. 2 shows a schematic view of a system used to control a sun blocking structure in a vehicle, in accordance with some described embodiments;

FIG. 3 shows an aerial view of an embodiment of a vehicle, showing the system integrated with the vehicle and a sun blocking structure, in accordance with some described embodiments;

FIGS. 4A and 4B show the vehicle positioned relative to sunlight, in accordance with some described embodiments;

FIGS. 5A and 5B show the vehicle positioned relative to sunlight in a different manner, in accordance with some described embodiments;

FIGS. 6A and 6B show the vehicle positioned relative to sunlight in yet a different manner, in accordance with some described embodiments;

FIGS. 7A-7C show embodiments of drive assemblies that can be operated by a system used in order to drive a sun blocking structure, in accordance with some described embodiments; and

FIG. 8 shows a flowchart describing a method for controlling a sun blocking structure for a motorized vehicle, in accordance with some described embodiments.

### DEFINITIONS

Various terms are used to refer to particular system components. Different companies may refer to a component by different names—this document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other devices and connections.

“Controller” shall mean, alone or in combination, individual circuit components, an application specific integrated circuit (ASIC), a microcontroller with controlling software, a digital signal processor (DSP), a processor with controlling software, or a field programmable gate array (FPGA), configured to read inputs and drive outputs responsive to the inputs.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

The following description is related to systems for controlling a sun blocking structure, or sun visor, in a vehicle. The systems described herein are designed to automatically drive the sun blocking structure to a location that is between ambient light (e.g., sunlight) and a person located in the vehicle (such as a driver of the vehicle), thereby relieving the person from direct eye exposure to the sunlight. Additionally, the sun blocking structure can be located within the vehicle such that the path of the sun blocking structure, while undergoing the automated movement, does not cause the sun blocking structure to strike, or otherwise contact, the person. Similarly, the person does not need to adjust his/her position in the vehicle during the automated movement of the sun blocking structure to avoid contact with the sun blocking structure.

A system (representing systems described herein) may include a controller designed to determine the location/position of the sunlight incident on the vehicle and operate hardware components to move the sun blocking structure to a desired location. In order to properly position the sun blocking structure, the system can account for movement of the vehicle as well as Earth's movement, as these variables change the location of sunlight incident on the vehicle. In this regard, the system may include a Global Positioning System (“GPS”) unit that obtains location information of the vehicle as well as current time and date information, and provides this information to the controller. The controller can use multiple location coordinates provided by the GPS unit, and compare the multiple location coordinates to determine the vehicle's direction of travel. Using vehicle direction information and current time and date information, the controller can determine the location of the sunlight that is incident on the vehicle.

The system is designed to operate a motor that drives the sun blocking structure. In this regard, the system may further include a motor controller. Based upon the determined location of the sunlight, the controller can generate instructions and provide the instructions to the motor controller. The motor controller can subsequently control the motor to drive the sun blocking structure to a location between the person and the sunlight. Further, in some example embodiments, in order to prevent contact between the person and the sun blocking structure, the motor is located above, or approximately above, the person, and the sun blocking structure is coupled to the motor by an arm or some intermediate structure(s). In this regard, when the motor is driven, the sun blocking structure can travel along a path (such as a semicircular path) about the motor, and effectively around the person, while the arm sufficiently displaces the sun blocking structure away from the person to avoid contact with the person.

During operation of the vehicle, the controller can continue to receive location information over predetermined time intervals to receive updated, real-time location information from the GPS unit. As a result, the controller can determine whether the vehicle's direction of travel is changing. When the direction of travel is changing, the controller can determine, based upon the updated direction of travel information, changes in the location of the sunlight that is incident on the vehicle and subsequently control the motor to adjust the position of the sun blocking structure to maintain the sun blocking structure between the sunlight and the person's eyes. Accordingly, the system provides real-time or near real-time responses to the change in the location of the sunlight.

In some embodiments, the system includes an additional motor coupled to the sun blocking structure. The additional motor can be driven, using the controller, to provide additional movement of the sun blocking structure. For example, the (initial) motor can act as a primary motor that drives the sun blocking structure about a primary axis defined, in example embodiments, by the primary motor, while the additional motor can act as a secondary motor that drives the sun blocking structure about a secondary axis. In this example, the primary motor provides a traversal path in which the sun blocking structure revolves about the primary motor, while the secondary motor provides a traversal path in which the sun blocking structure rotates about the secondary axis. In this manner, the primary motor provides a coarse (or large-scale) movement of the sun blocking structure, and the secondary motor provides a fine tune (or small-scale) movement of the sun blocking structure. These primary and secondary motors can be used to provide adjustments to the sun blocking structure while the vehicle encounters turns on a surface (e.g., road, street, or highway).

Also, in some embodiments, the system includes an electronic map that contains information related to the surface on which the vehicle is located. In this regard, the system can use the GPS unit to determine the vehicle's location on the surface and anticipate upcoming corners or turns on the surface in which the vehicle will encounter.

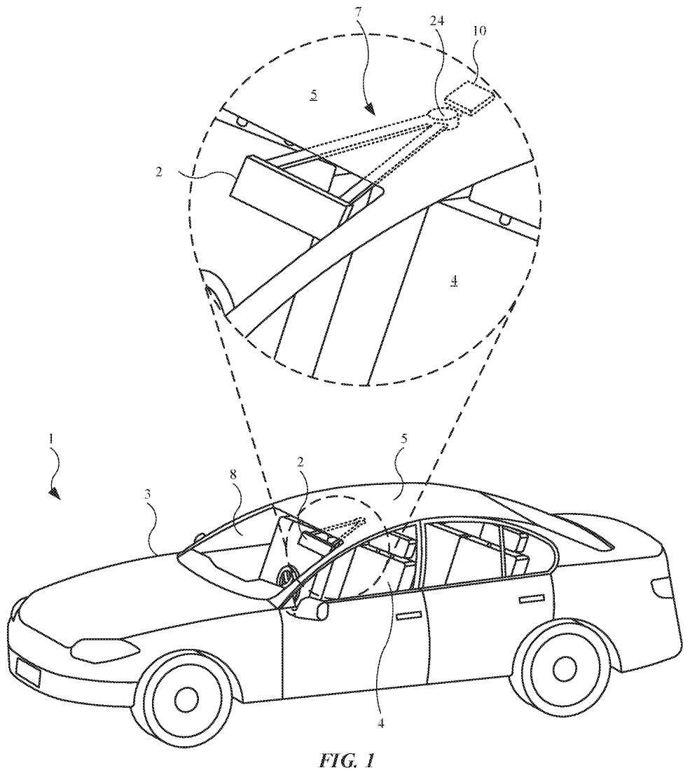

FIG. 1 shows an isometric view of an embodiment of a vehicle 1 with a sun blocking structure 2. The vehicle 1 may include a motorized vehicle, and accordingly, includes a motor (not shown in FIG. 1) designed to drive multiple wheels during operation of the vehicle 1. As shown, the vehicle 1 is a sedan. However, the vehicle 1 is representative of several various motorized vehicles, such as a sport utility vehicle, a pickup truck, a van, or a commercial vehicle (e.g., moving truck, dump truck, semi-truck), as non-limiting examples.

As shown, the vehicle 1 includes a vehicle body 3 that defines the exterior of the vehicle 1. The vehicle body 3 is designed to carry several structures of the vehicle 1. For example, the vehicle body 3 carries a seat 4 in which a person (not shown in FIG. 1) is seated and positioned to operate the vehicle 1. The vehicle body 3 includes a ceiling 5, or roof. As shown in the enlarged view, the sun blocking structure 2 is coupled to the vehicle body 3 at the ceiling 5. The vehicle 1 may include arms 7 that extend from the system and connects the sun blocking structure 2 to a motor 24.

Further, the vehicle 1 includes a system 10 that is designed to drive the sun blocking structure 2. In this manner, the system 10 can drive the motor 24, which in turn guides the sun blocking structure 2 to a location in which the sun blocking structure 2 is positioned between sunlight from the sun and the person sitting on the seat 4. Further, the system 10 is designed to track the location of the sunlight incident on the vehicle 1 during operation (e.g., driving) of the vehicle 1, and automatically drive the motor 24 such that the sun blocking structure 2 remains positioned between the determined location of the sunlight and the person located on the seat 4. Although the sun blocking structure 2 is positioned between the sunlight and the person, it should be noted that the sun blocking structure 2 is positioned so as to not block the person's eyes. For instance, in FIG. 1, when sunlight is incident on a windshield 8 of the vehicle, the sun blocking structure 2 is positioned to shield the person's eyes from direct exposure of the sunlight while still allowing the person to view through the windshield 8 and safely the vehicle 1.

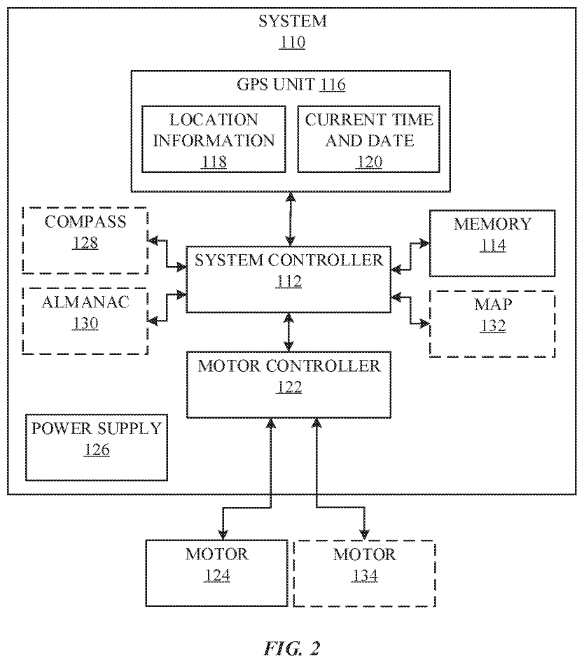

FIG. 2 shows a schematic view of a system 110 used to control a sun blocking structure in a vehicle, in accordance with some described embodiments. The system 110 is representative of other systems described herein such as the system 10 shown in FIG. 1. As shown, the system 110 may include a system controller 112 designed to receive communication from input devices and use the communication to provide controls to other devices. The system controller 112 may include a programmable logic controller or one or more microcontrollers, as non-limiting examples.

The system 110 may further include memory 114 that stores programs and/or algorithms used by the system controller 112 to communicate with the various components of the system 110 that will be discussed below. The memory 114 may include a memory circuit (or circuits) that includes volatile, non-volatile, or solid-state memory. In other cases, the memory 114 may be a part of the system controller 112.

The system 110 may further include a GPS unit 116 designed to receive information broadcasted by multiple GPS satellites. For instance, the GPS unit 116 can receive, from a GPS satellite, a timestamp and position of the GPS satellite at the time of broadcast. Further, the GPS unit 116 can compare the time difference between the sending and receiving of the information (from each GPS satellite) and determine the distance between the GPS unit 116 and each GPS satellite. As a result, the location of the system 110 can be determined by the GPS unit 116. As a result of the determined location, the GPS unit 116 can also determine location information 118, such as latitude and longitude coordinates. In some embodiments, the GPS unit 116 compares multiple sets of location coordinates from the location information 118 and determines a direction of travel of a motorized vehicle that integrates the system 110. The direction of travel information can be sent to the system controller 112. Alternatively, the using a program or algorithm stored on the memory 114, the system controller 112 can use the multiple sets of location coordinates from the location information 118 and determine a direction of travel of a motorized vehicle. In either event, the system controller 112 can use the direction of travel to approximate the location of sunlight that is incident on the motorized vehicle.

Additionally, the GPS unit 116 can provide current time and date information 120 (received from at least one of the GPS satellites) to the system controller 112. Using a program or algorithm stored on the memory 114, the system controller 112 can use the current time and date information 120 to determine the location of the sun and accordingly, the location of the sunlight that is incident on the motorized vehicle. Moreover, the system controller 112 can use both the direction of travel and the current time and date information 120 to further approximate the location of sunlight that is incident on the motorized vehicle.

When the system controller 112 determines an approximate location of sunlight that is incident on the motorized vehicle, the system controller 112 can generate and provide instructions used to drive a sun blocking structure (such as the sun blocking structure 2 shown in FIG. 1). In this regard, the system 110 may include a motor controller 122. When the approximate location of sunlight that is incident on the motorized vehicle is determined, the system controller 112 can execute instructions from a program or algorithm stored on the memory 114, and provide instructions to the motor controller 122. The motor controller 122 can use the instructions, and subsequently generate and provide a control signal to the motor 124 to drive the sun blocking structure and position the sun blocking structure between the sunlight incident on the vehicle and a person (e.g., driver) in the vehicle. The motor 124 may include an alternate an alternating current (“AC”) motor, a direct current (“DC”) motor, a servomotor, or a stepper motor, as non-limiting examples. Also, while the motor 124 is shown as being separate from the system 110, in some embodiments, the motor 124 is included in the system 110. Also, the system 110 may further include a power supply 126 that provides energy to the components of the system 110, and may also supply energy to the motor 124. Alternatively, or in combination, the system 110 may use energy provided by the vehicle.

In some embodiments, the system 110 may include additional optional components. For example, the system 110 may include a compass 128. The compass 128 may be used in to confirm or adjust the direction of travel determined by the system controller 112 using the location information 118.

Also, in some embodiments, the system 110 may include an almanac 130. The almanac 130 may include an astronomical almanac that stores solar data information, such as sunrise/sunset times for future dates. In this regard, when the current time and date information 120 is provided to the system controller 112, the system controller 112 can look up sunrise/sunset times of the current date from the almanac 130, thereby providing the system controller 112 with the sunrise/sunset times for the current time and day. As a result, the system controller 112 can further approximate the location of sunlight that is incident on the motorized vehicle. In order to update the solar data information, the almanac 130 may use a wireless transceiver to communicate with a network (cellular network or the Internet) to retrieve updated information stored on a cloud-based network, as a non-limiting example. Also, in order to further approximate the location of the sunlight, the almanac 130 may use the location information 118 and the current time and date information 120 from the GPS unit 116 to look up the sunrise/sunset times based on the current latitude and longitude of the system 110. Further, the almanac 130 may further use the location information 118 and the current time and date information 120 from the GPS unit 116 to look up the solar angle (i.e., the angle of the sun relative to the system 110) based on the current latitude and longitude of the system 110 and the current time and date information 120. Also, in some embodiments, the almanac 130 uses the solar data information to determine or estimate, by interpolation between the sunrise/sunset times, the solar position and accordingly location of the ambient light from the sun. Accordingly, in some embodiments, the information provided by the almanac 130 may be used by the system 110 to more accurately determine the location of the sunlight.

Also, in some embodiments, the system 110 includes a map 132 that contains information related to a surface (e.g., road, street, or highway) on which the vehicle is located. The map 132 may include electronic map information related to a surface (or surfaces) that surrounds the vehicle. In this regard, the system controller 112 can use the GPS unit 116 to determine the vehicle's location on the surface and anticipate upcoming corners or turns on the surface in which the vehicle will encounter. For example, using the surface information from the map 132 and the GPS unit 116, the system controller 112 can anticipate the location of the ambient light incident on the vehicle, and provide instructions to the motor controller 122 that cause the motor 124 to drive the sun blocking structure between the ambient light and the person's eyes when the vehicle reaches the corner or turn.

Optionally, in some embodiments, the system controller 112 is designed to provide instructions to the motor controller 122 that drives a second motor 134. In these embodiments, the motor 124 provides a force that drives a sun blocking structure along a pre-defined path, while the second motor 134 provides a rotational force that rotates the sun blocking structure. In this manner, the system 110 can increase the number of angular positions of the sun blocking structure, thereby providing additional shielding from sunlight. The second motor 134 may include any type of motor previously described for the motor 124.

It should be noted that the system 110 is designed for real-time use while a person is driving a motorized vehicle. Accordingly, while the motorized vehicle is in use, the GPS unit 116 can receive and provide location information 118 and current time and date information 120 periodically to the system controller 112, and accordingly, the system controller 112 can provide updated instructions periodically to the motor controller 122. As a result, the motor controller 122 can drive the motor 124 to adjust the position of the sun blocking structure 202 such the sun blocking structure remains between the sun light and the person while the person is driving.

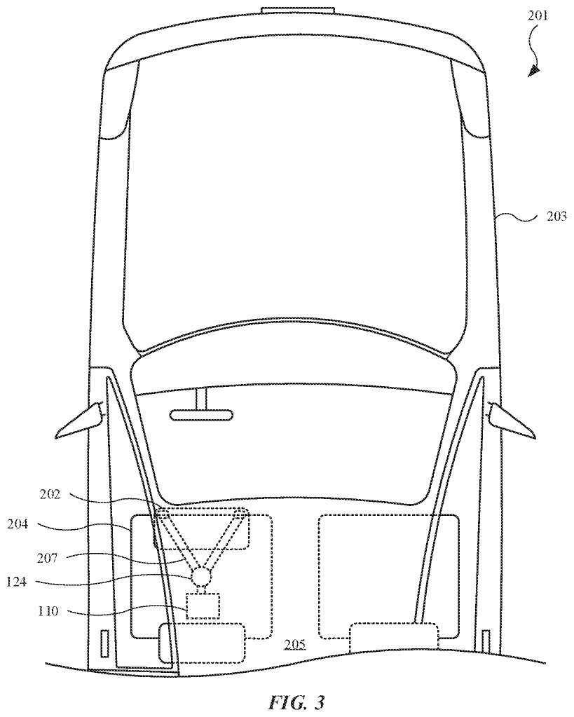

FIG. 3 shows an aerial view of an embodiment of a vehicle 201, showing the system 110 integrated with the vehicle 201 and a sun blocking structure 202, in accordance with some described embodiments. The system 110 and the motor 124 are shown and described in FIG. 2. Also, the vehicle 201 may include any features previously described for the vehicle 1 (shown in FIG. 1). As shown, the vehicle 201 includes a vehicle body 203 that holds a seat 204. Further, the vehicle body 203 includes a ceiling 205 that covers the seat 204. Also, the sun blocking structure 202 is in an initial, or stored, position such that the sun blocking structure 202 is approximately parallel with respect to the ceiling 205. In the initial position, the system 110 is in an inactive configuration or inactive mode, and accordingly, is inoperable. However, the sun blocking structure 202 can be activated in a deployed position (shown below) and subsequently be rendered operable.

In the example system, the motor 124 is positioned over the seat 204 and connected to the sun blocking structure 202 by arms 207. Further, in the example system, the motor 124 is positioned, or at least approximately positioned, over a center point of a seat rest portion of the seat 204, and the arms 207 extend the sun blocking structure 202 over, or at least approximately over, an outer perimeter of the seat rest portion of the seat 204. In this manner, when the motor 124 drives the sun blocking structure 202, the sun blocking structure 202 is sufficiently located away from a person (not shown in FIG. 3) sitting on the seat 204, and the sun blocking structure 202 does not contact the person.

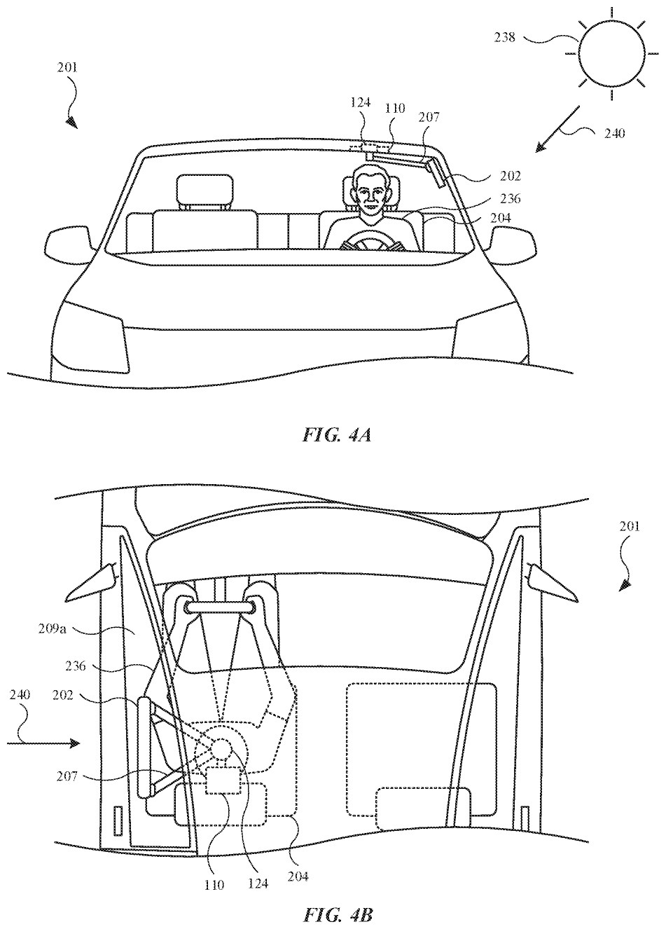

FIGS. 4A and 4B show the vehicle 201 positioned relative to sunlight, in accordance with some described embodiments. As shown, a person 236 is located in the seat 204 and is operating the vehicle 201. As shown in FIG. 4A, the sun 238 provides sunlight (represented by an arrow 240) to the “driver's side” of the vehicle 201, and through a driver's side window 209a of the vehicle 201. Also, the sun blocking structure 202 is rotated away from the ceiling 205 and in a deployed positioned to shield the person 236 from the sunlight. Based on the deployed position, the system 110 is in an active mode. In this manner, the system 110 can use the GPS unit 116 (shown in FIG. 2) to obtain information from GPS satellites (not shown in FIGS. 4A and 4B) and determine the location information 118, and provide the location information 118 and the current time and date information 120 to the system controller 112 (shown in FIG. 2). Further, when the person 236 is driving the vehicle 201, the GPS unit 116 (or the system controller 112, in some cases) can determine a direction of travel of the vehicle 201. The system controller 112 can use the direction of travel and the current time and date information 120 to determine that the sunlight from the sun 238 is directed toward the driver's side of the vehicle 201.

Based on the determined location of the sunlight on the vehicle 201, the system controller 112 can subsequently provide instructions to the motor controller 122 (shown in FIG. 2), and the motor controller 122 can provide a control signal to the motor 124, thereby directing the motor 124 to drive the sun blocking structure 202 to a location between the sunlight and the driver's side window 209a, and in particular, between the sunlight and the person 236. The motor 124 can define an axis around which the sun blocking structure 202 revolves. Based on the motor 124 defining the axis and the length of the arms 207, the sun blocking structure 202 does not contact the person 236.

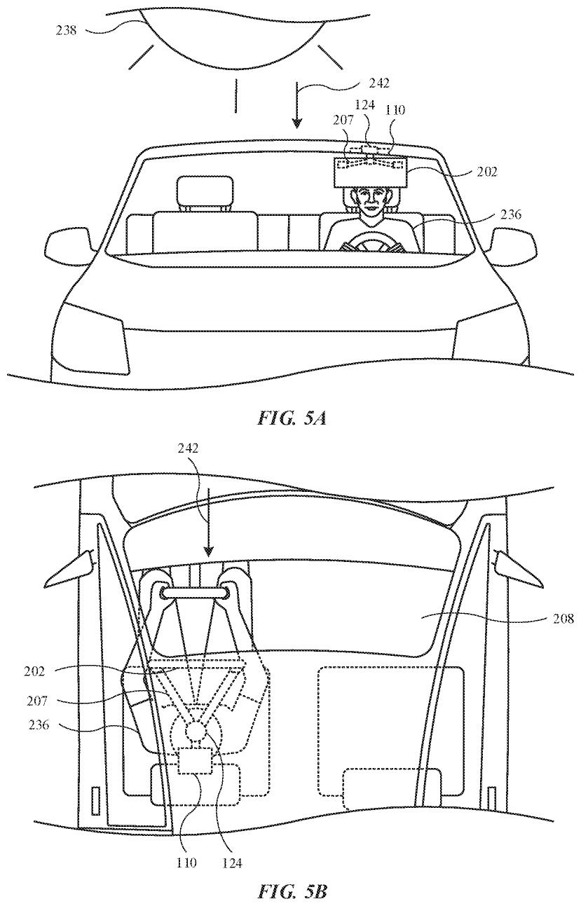

FIGS. 5A and 5B show the vehicle 201 positioned relative to sunlight in a different manner, in accordance with some described embodiments. Based upon the person 236 driving the vehicle 201, the time lapse, and/or the direction of travel of the vehicle 201, the sun 238 subsequently provides sunlight (represented by an arrow 242) through a windshield 208 of the vehicle 201. The system 110 can adjust the location of the sun blocking structure 202 based upon changes in the location of the sunlight, and position the sun blocking structure 202 to shield the person 236 from the sunlight passing through windshield 208. Accordingly, the system 110 can use the GPS unit 116 (shown in FIG. 2) to obtain information from GPS satellites (not shown in FIGS. 5A and 5B) and determine updated location information and updated current time and date information, and provide the updated information to the system controller 112 (shown in FIG. 2). Also, the GPS unit 116 (or the system controller 112, in some cases) can determine an updated direction of travel of the vehicle 201. The system controller 112 can use the updated direction of travel and updated current time and date information to determine that the sunlight from the sun 238 is directed toward the windshield 208.

Based on the determined location of the sunlight on the vehicle 201, the system controller 112 can subsequently provide updated instructions to the motor controller 122 (shown in FIG. 2), and the motor controller 122 can provide an updated control signal to the motor 124, thereby directing the motor 124 to drive the sun blocking structure 202 to a location between the sunlight and the windshield 208, and in particular, between the sunlight and the person 236. Also, the sun blocking structure 202 does not contact the person 236 while changing positions.

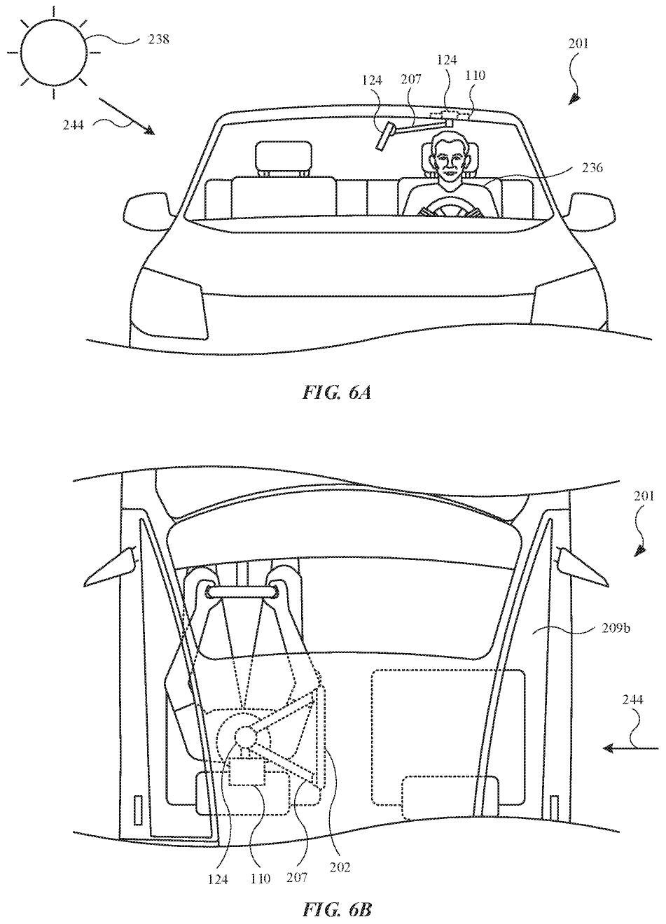

FIGS. 6A and 6B show the vehicle positioned relative to ambient light in yet a different manner, in accordance with some described embodiments. Based upon the person 236 driving the vehicle 201, the time lapse, and/or the direction of travel of the vehicle 201, the sun 238 provides sunlight (represented by an arrow 244) to the “passenger's side” of the vehicle 201, and through a passenger's side window 209b of the vehicle 201. The system 110 can adjust the location of the sun blocking structure 202 based upon changes in the location of the sunlight, and position the sun blocking structure 202 to shield the person 236 from the sunlight passing through the passenger's side window 209b. Accordingly, the system 110 can use the GPS unit 116 (shown in FIG. 2) to obtain information from GPS satellites (not shown in FIGS. 6A and 6B) and determine updated location information and updated current time and date information, and provide the updated information to the system controller 112 (shown in FIG. 2). Also, the GPS unit 116 (or the system controller 112, in some cases) can determine an updated direction of travel of the vehicle 201. The system controller 112 can use the updated direction of travel and updated current time and date information to determine that the sunlight from the sun 238 is directed toward the passenger's side window 209b.

Based on the determined location of the sunlight on the vehicle 201, the system controller 112 can subsequently provide updated instructions to the motor controller 122 (shown in FIG. 2), and the motor controller 122 can provide an updated control signal to the motor 124, thereby directing the motor 124 to drive the sun blocking structure 202 to a location between the sunlight and the passenger's side window 209b, and in particular, between the sunlight and the person 236. Also, the sun blocking structure 202 does not contact the person 236 while changing positions.

The exemplary movement of the sun blocking structure 202 shown in FIGS. 4A-6B shows three distinct positions. For example, the position of the sun blocking structure in FIGS. 4A and 4B may be referred to as a “zero angle,” or reference angle. Also, the position of the sun blocking structure 202 in FIGS. 5A and 5B may be positioned 90 degrees relative to the zero angle, and the position of the sun blocking structure 202 in FIGS. 6A and 6B may be positioned 180 degrees relative to the zero angle. Accordingly, the sun blocking structure 202 can span (or revolve) 180 degrees around the motor 124. However, it should be noted that the position of the sun blocking structure 202 may also include any angle between 0 and 180 degrees relative to the zero angle. In this regard, the three positions shown in FIGS. 4A-6B should not be construed to limit the movement of the sun blocking structure 202 by the system 110 to three locations. Also, it should be noted that the system 110 may also rely on the optional components shown in FIG. 2 (the compass 128, the almanac 130, and/or the map 132), when incorporated with the system 110, to position the sun blocking structure 202. Also, it should be noted that the system 110 can further control the second motor 134 shown in FIG. 2, when incorporated in the vehicle 201 and coupled with the sun blocking structure 202, in order to further position the sun blocking structure 202.

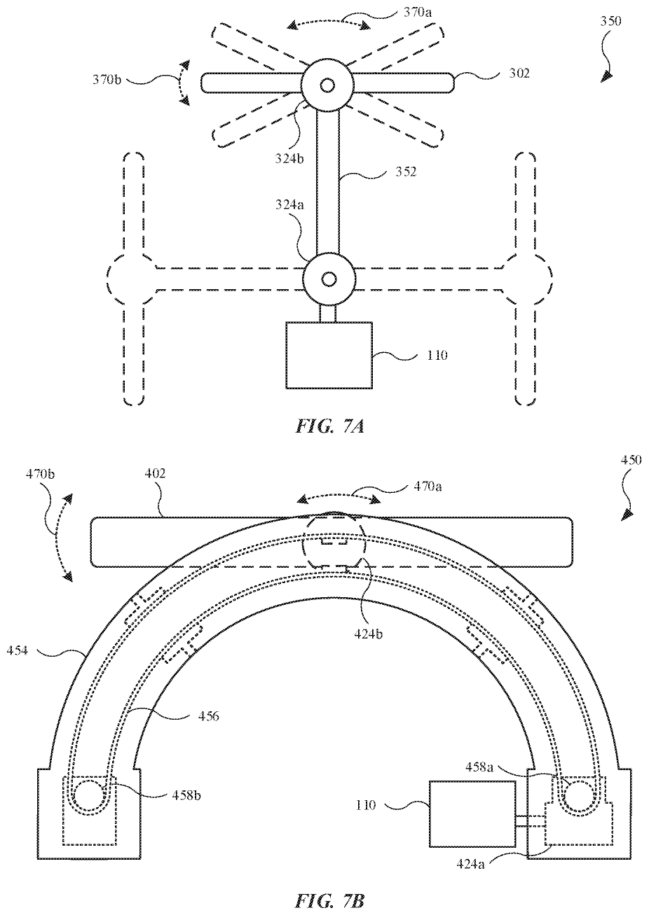

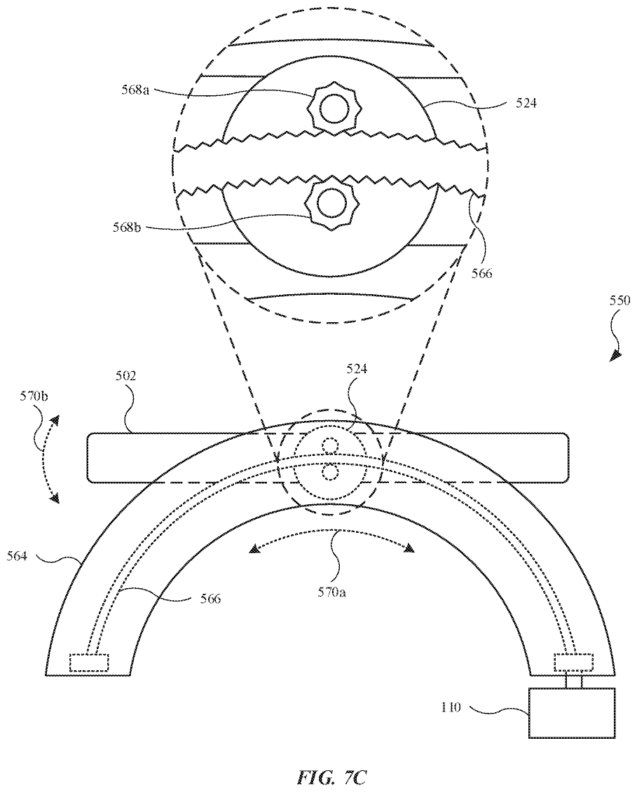

FIGS. 7A-7C show embodiments of drive assemblies that can be operated by a system used to drive a sun blocking structure, in accordance with some described embodiments. The drive assemblies shown and described in FIGS. 7A-7C can replace the arms 207 shown in FIGS. 3-6B. Accordingly, the drive assemblies shown and described in FIGS. 7A-7C can be integrated into the vehicle 201 shown in FIGS. 3-6B. Further, the drive assemblies can be integrated with the system 110 such that the system can control the motor(s) of the respective drive assemblies shown in FIGS. 7A-7C. Also, similar to prior embodiments, the system 110 can receive broadcast information from GPS satellites and determine, based on this information, direction of travel, current time and date information, and when applicable, information from a compass, an almanac, and/or a map, and control the motor(s) shown and described in FIGS. 7A-7C.

FIG. 7A shows an aerial view of an embodiment of a drive assembly 350 that includes an arm 352 connected a sun blocking structure 302. As shown, the drive assembly 350 includes a motor 324a connected to the arm 352. The arm 352 is further connected to the sun blocking structure 302 by a motor 324b. The system 110 can control the motor 324a to drive the sun blocking structure 302, the motor 324b, and the arm 352 along a path (represented by an arrow 370a) to the locations corresponding to the dotted lines, as well as any location between the locations represented by the dotted lines. In this regard, the sun blocking structure 302, the motor 324b, and the arm 352 can revolve around the motor 324a.

In order to provide further movement of the sun blocking structure 302, the system 110 can further control the motor 324b to drive the sun blocking structure 302 along a path (represented by an arrow 370b). In this regard, the sun blocking structure 302 can rotate around the motor 324b. Accordingly, the motor 324a and the motor 324b can each define an axis about which the sun blocking structure 302 can move. As a result, the sun blocking structure 302 can achieve greater flexibility in terms of movement, and when the drive assembly 350 is integrated with a vehicle, the sun blocking structure 302 can provide additional shielding to a person from sunlight.

FIG. 7B shows an aerial view of an alternate embodiment of a drive assembly 450 that includes a track system 454 connected a sun blocking structure 402. As shown, the drive assembly 450 includes a motor 424a connected to a drive structure 456. The drive structure 456 may include a chain or a cable, as non-limiting examples. Also, the motor 424a and the drive structure 456 are located in the track system 454. However, the motor 424a may lie at least partially outside the track system 454 in some embodiments. Also, the drive assembly 450 further includes a motor 424b that is coupled to the drive structure 456 and the sun blocking structure 402.

The drive assembly 450 further includes a rolling element 458a that is driven (i.e., rotated) by the motor 424a. In this manner, the system 110 can control the motor 424a to rotate the rolling element 458a such that the drive structure 456 moves along the rolling element 458a and a rolling element 458b. Further, the sun blocking structure 402 moves in conjunction with the drive structure 456. The sun blocking structure 402 and the drive structure 456 can move along a path (represented by an arrow 470a) from the rolling element 458a to the rolling element 458b, as well as any location between the rolling element 458a and the rolling element 458b. In this regard, the sun blocking structure 402 can move along a path that is defined by the drive structure 456. As shown, the drive structure 456 defines a semi-circular path that provides the sun blocking structure 402 with 180 degrees of movement from the rolling element 458a to the rolling element 458b. However, other paths are possible. For example, the drive structure 456 may define a path that is greater than the semi-circular path shown in FIG. 7B, such as a path that provides the sun blocking structure 402 with 270 or 300 degrees of movement.

In order to provide further movement of the sun blocking structure 402, the system 110 can further control the motor 424b to drive the sun blocking structure 402 to rotate around the motor 424b along a path (represented by an arrow 470b). Accordingly, the drive structure 456 defines a path for the sun blocking structure 402, while the motor 424b defines an axis about which the sun blocking structure 402 can move. As a result, the sun blocking structure 402 can achieve greater flexibility in terms of movement, and when the drive assembly 450 is integrated with a vehicle, the sun blocking structure 402 can provide additional shielding to a person from sunlight.

FIG. 7C shows an aerial view of an alternate embodiment of a drive assembly 550 that includes a gear system 564 connected a sun blocking structure 502. As shown, the drive assembly 550 includes a motor 524 connected to a gear structure 566. The outer perimeter of the gear structure 566 may include a saw tooth shape or some other geared structure, as non-limiting examples. Also, the motor 524 is connected to the sun blocking structure 502.

As shown in the enlarged view, the motor 524 includes a geared rolling element 568b and a geared rolling element 568b. The geared rolling element 568a and the geared rolling element 568b are engaged with the gear structure 566. The motor 524 is designed to drive (i.e., rotate) the geared rolling element 568a and the geared rolling element 568b in different rotational directions, thereby causing the sun blocking structure 502 and the motor 524 to move along a path (represented by an arrow 570a) along the gear structure 566. In order to move the sun blocking structure 502 and the motor 524 along the gear structure 566, the motor 524 can rotate the geared rolling element 568a in the clockwise direction, while also rotating the geared rolling element 568b in the counterclockwise direction. In order to move the sun blocking structure 502 and the motor 524 along the gear structure 566 in the opposite direction, the motor 524 can rotate the geared rolling element 568a in the counterclockwise direction, while also rotating the geared rolling element 568b in the clockwise direction. The gear structure 566 may act as a track for the sun blocking structure 502. The gear structure 566 may define a semi-circular path that provides the sun blocking structure 502 with 180 degrees of movement. However, other paths are possible. For example, the gear structure 566 may define a path that is greater than the semi-circular path shown in FIG. 7C, such as a path that provides the sun blocking structure 502 with 270 or 300 degrees of movement.

In order to provide further movement of the sun blocking structure 502, the system 110 can further control the motor 524 to drive the sun blocking structure 502 to rotate around the motor 524 along a path (represented by an arrow 570b). For example, the motor 524 can rotate both the geared rolling element 568a and the geared rolling element 568b in the clockwise to rotate the sun blocking structure 502 in one direction, and subsequently rotate both the geared rolling element 568a and the geared rolling element 568b in the counterclockwise to rotate the sun blocking structure 502 in the opposite direction. Accordingly, while the gear structure 556 provides a path for the sun blocking structure 502, the motor 524 defines an axis about which the sun blocking structure 502 can move.

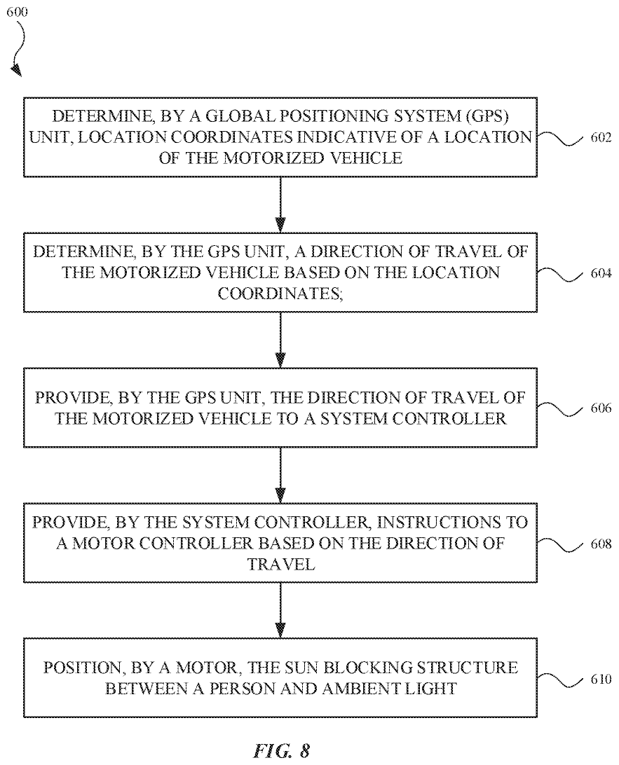

FIG. 8 shows a flowchart 600 describing a method for controlling a sun blocking structure for a motorized vehicle, in accordance with some described embodiments. The steps shown and described for the flowchart 600 can be implemented by the system 110 described herein. Accordingly, steps shown and described for the flowchart 600 can be use to control the movement of a sun blocking structure described herein.

In step 602, a Global Positioning System (GPS) unit determines location coordinates indicative of a location of the motorized vehicle. The GPS unit can receive information broadcast by multiple GPS satellites to determine location information and current time and date information.

In step 604, the GPS unit determines a direction of travel of the motorized vehicle based on the location coordinates. As an example, the GPS unit can compare multiple sets of location coordinates from the location information and determine the direction of travel of the motorized vehicle.

In step 606, the GPS unit provides the direction of travel of the motorized vehicle to a system controller. The system controller can use the direction of travel to approximate the location of sunlight that is incident on the motorized vehicle. Additionally, the GPS unit can provide the current time and date information to the system controller, thereby providing information for the system controller to further approximate the location of sunlight that is incident on the motorized vehicle. In some instances, the system control can receive further information to further approximate the location of sunlight incident on the motorized vehicle. For example, the system control can receive direction of travel information from a compass, solar data information from an almanac, and/or map information of a surface on which the motorized vehicle is traveling.

In step 608, the system controller provides instructions to a motor controller based on the direction of travel. The motor controller can be configured to generate a control signal based on the instructions.

In step 610, a motor positions the sun blocking structure between a person and ambient light, which may include sunlight. In order to control the motor, the control signal from the motor controller is provided to the motor. Also, when a second motor is incorporated into the motor vehicle for use with the sun blocking structure, the system controller can provide instructions to the motor controller in order to drive the second motor. In these embodiments, the initial motor provides a force that drives a sun blocking structure along a pre-defined path, while the second motor provides a rotational force that rotates the sun blocking structure.

Many of the electrical connections in the drawings are shown as direct couplings having no intervening devices, but not expressly stated as such in the description above. Nevertheless, this paragraph shall serve as antecedent basis in the claims for referencing any electrical connection as “directly coupled” for electrical connections shown in the drawing with no intervening device(s).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system for controlling a sun blocking structure in an automobile, the system comprising:
an input mechanism configured to receive an input;
a controller configured to receive the input from the input mechanism and configured to generate instructions based on the one or more inputs; and
a motor configured to drive the sun blocking structure around a person in the automobile and locate the sun blocking structure between the person and ambient light based on the instructions from the controller.

2. The system of claim 1, wherein the input mechanism comprises a Global Positioning System (GPS) unit, and wherein the input comprises location coordinates provided by the GPS unit.

3. The system of claim 2, wherein the controller is configured to determine a direction of travel of the automobile based on the location coordinates, and wherein the controller is configured to provide the instructions based on the direction of travel.

4. The system of claim 3, wherein the controller is further configured to receive solar data information and provide the instructions based on the solar data information.

5. The system of claim 1, wherein the motor defines an axis, and the sun blocking structure is configured to revolve about the axis.

6. The system of claim 5, wherein the motor is further configured to rotate the sun blocking structure about an axis of rotation that intersects the sun blocking structure.

7. The system of claim 1, wherein the motor is configured to translate the sun blocking structure along a semicircular path.

8. The system of claim 1, further comprising a track, wherein the motor is configured to move the track.

9. The system of claim 8, wherein the track defines a semicircular path.

10. A motorized vehicle, comprising:
a vehicle body comprising a ceiling;
a seat located in the vehicle body and covered by the ceiling;
a Global Positioning System (GPS) unit carried by the vehicle body, the GPS unit configured to determine location coordinates;
a controller carried by the vehicle body, the controller configured to i) receive the location coordinates, ii) determine a direction of travel of the vehicle body, and iii) generate instructions based on the direction of travel; and
a motor coupled with the ceiling and a sun blocking structure, the motor configured to translate, based on the instructions, the sun blocking structure around the seat.

11. The motorized vehicle of claim 10, wherein an inactive mode comprises the sun blocking structure positioned approximately parallel with the ceiling and the motor is rendered inoperable.

12. The motorized vehicle of claim 10, wherein the motor is configured to translate the sun blocking structure around a person sitting on the seat and locate the sun blocking structure between the person and sunlight that is incident on the vehicle body.

13. The motorized vehicle of claim 10, further comprising a memory circuit that stores solar data information that includes solar position based on time and date, wherein the controller is configured to generate the instructions based on solar data, the direction of travel, and current time and date information.

14. The motorized vehicle of claim 10, wherein the motor defines a central axis of rotation of the sun blocking structure.

15. The motorized vehicle of claim 10, wherein the motor is configured to revolve the sun blocking structure along a semicircular path, and wherein the motor is further configured to rotate the sun blocking structure.

16. A method for controlling a sun blocking structure for a motorized vehicle, the method comprising:
determining, by a Global Positioning System (GPS) unit, location coordinates indicative of a location of the motorized vehicle;
determining, by the GPS unit, a direction of travel of the motorized vehicle based on the location coordinates;
providing, by the GPS unit, the direction of travel of the motorized vehicle to a system controller;
providing, by the system controller, instructions to a motor controller based on the direction of travel, the motor controller configured to generate a control signal based on the instructions; and
positioning, by a motor, the sun blocking structure between a person and ambient light based on the control signal being provided to the motor.

17. The method of claim 16, further comprising:
receiving solar data information;
receiving current time and date information; and
generating the instructions, by the system controller, based on the direction of travel, the solar data information, and the current time and date information.

18. The method of claim 16, further comprising translating, by the motor, the sun blocking structure along a track.

19. The method of claim 18, further comprising, translating the sun blocking structure along a semicircular path.

20. The method of claim 18, further comprising rotating, by the motor, the sun blocking structure about an axis.
